(19) United States
(12) Patent Application Publication
(10) Pub. No.: US 2007/0264871 A1
(43) Pub. Date: Nov. 15, 2007

(54) Coaxial Cable Soldering Method and Equipment

(76) Inventor: Kazuya Okano, Kanagawa (JP)

Correspondence Address: HARRINGTON & SMITH, PC, 4 RESEARCH DRIVE, SHELTON, CT, 06484-6212, US

(21) Appl. No.: 10/594,197

(22) PCT Filed: Mar. 31, 2005
(86) PCT No.: PCT/JP05/06286

§ 371 Date: Jun. 21, 2007

(30) Foreign Application Priority Data
Mar. 31, 2004 (JP) 2004-107909

(51) Int. Cl. H01R 9/05

(52) U.S. Cl. 439/578

(57) ABSTRACT

Prevents solder from flowing into the coaxial cable side when performing soldering. A method and device is presented that is a soldering method for thin coaxial cable, including a step for placing a shield of a coaxial cable on a grounding bar, a step for supplying solder to the grounding bar or the shield, a step for installing a cooling member next to and in contact with the grounding bar, and a step for soldering together the grounding bar and the coaxial cable, wherein the region of the coaxial cable next to and in contact with the cooling member is cooled, thereby preventing the flow of solder into regions other than the portions to be soldered.

### TECHNICAL FIELD

The present invention concerns a cooling member that absorbs heat conducted from a soldering iron during soldering, a coaxial cable using this, and particularly, a method for soldering thin coaxial cable.

### BACKGROUND ART

Usually, solder and physical contact with a soldering device are used to connect electrical parts. However, due to the miniaturization of electrical equipment in recent years, especially in connectors, many restrictions arise when connecting is done using solder.

### DISCLOSURE OF THE INVENTION

[Problem to be Solved by the Invention]

When connecting a thin conducting wire such as a thin coaxial cable to a connector, a grounding bar is connected to the shield portion surrounding the conducting wire, but when soldering, since the heat due to soldering is conducted to the jacket side of the coaxial cable, molten solder sometimes flows along the shield line towards the jacket. If the solder hardens, then one portion of the conducting wire that is exposed to the outside of the connector loses its flexibility.

In this case, when using a connector to small devices such as mobile devices, when inserting a conducting wire along with a connector into a narrow space, said conducting wire sometimes cannot be bent, or cannot be flexed, at a portion close to the connector, so this can cause the workability of the attaching of connectors to worsen. In order to solve such problems, it is necessary to prevent the flow of solder to the jacket side of the coaxial cable.

[Means for Solving the Problem]

In the light of the problems described above, the present invention provides a soldering method that is a soldering method for thin coaxial cables, including a step wherein the shield of the coaxial cable is placed on the grounding bar, a step wherein solder is supplied to the grounding bar or the shield, a step wherein a cooling member is installed next to and in contact with the grounding bar, and a step wherein the grounding bar and the coaxial cable are soldered, and in which a region next to and in contact with the cooling member is cooled, and the flowing of solder into a region other than the soldering portion is prevented. Whereby, the flowing of solder to the jacket side can be prevented.

Here, the cooling is of the portion next to and in contact with the grounding bar, and the temperature of the coaxial cable at said portion can be maintained at 150 degrees Celsius or below. Whereby, the flow of solder can be prevented.

As a device that realizes such a method, a cooling member is provided that is a cooling member for soldering, said cooling member being able to have a coaxial cable pass through it, and having a pass-through hole for holding said coaxial cable, and a contact region that can come into contact with the region next to the portion on which the soldering is to be done, and which, during soldering with a grounding bar, the heat that is conducted from the portion being soldered to the coaxial cable side is absorbed by the contact region, said region being able to be kept at below the melting point of the solder.

As described above, this cooling member can keep the cooling region at below 150 degrees Celsius. Whereby, if this method or device is applied to a connector, a connector that can be bent flexibly from the connecting portion of the coaxial cable can be realized.

Since, as described above, the flow of solder can be blocked, even if the grounding bar that is fixed to the housing is fixed with solder, the coaxial cable connected to the grounding bar can be bent without losing flexibility.

[Effects of the Invention]

Due to the present invention, the flowing of solder to the jacket side of a coaxial cable can be prevented. This is effective particularly for small connectors.

### BRIEF DESCRIPTION OF THE DRAWINGS

FIG. 1 is a diagram of the invention after having soldered together the shield of a coaxial cable and a grounding bar using the cooling member of the present invention.

FIG. 2 is a cross section of the cooling member of the present invention while in use.

FIG. 3 is an oblique perspective view showing the grounding bar being connected to the housing.

### EXPLANATION OF THE INDEX NUMBERS

1 Cooling Member
2 Coaxial Cable
3 Cooling Surface
4 Conducting Wire
5 Soldering Device
6 Grounding bar
7 Shield
8 Aligning Means
9 Portion to be Soldered

### BEST MEANS FOR EMBODYING THE INVENTION

The present invention is one whereby, when a thin conducting wire such as a thin coaxial cable is connected to a connector, a grounding bar is connected to a shield portion surrounding the conducting wire, and when soldering is performed, the flow of solder is prevented by cooling the coaxial cable in the vicinity of the portion whereon soldering is performed. This utilizes the fact that since the melting point of solder is approximately 150 degrees Celsius, solder will lose its fluidity at temperature regions lower than this. Herebelow, the device shall be explained concretely.

FIG. 1 is a schematic view of when a grounding bar 6 is connected using the cooling member 1 and the cooling method of the present invention. The grounding bar 6 is soldered to the shield (not shown in this figure) of the coaxial cable 2, but since the solder does not flow along the shield line into the jacket side, as shall be explained in detail below, the coaxial cable will be flexible from the base of the connecting portion. Additionally, the conducting wire 4 is an axis line that conducts signals, and is an axis line that is ultimately connected to a terminal of the connector.

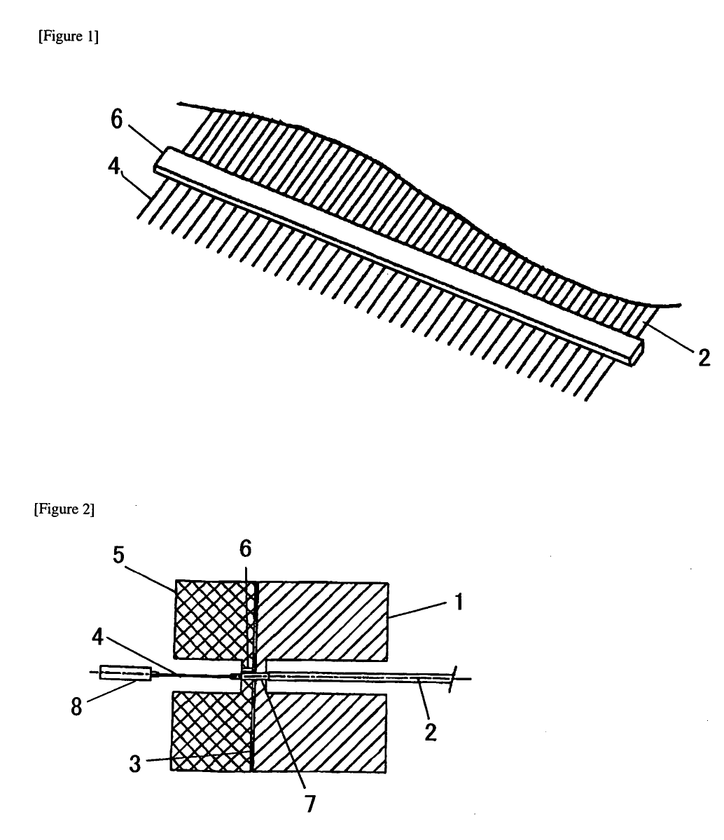

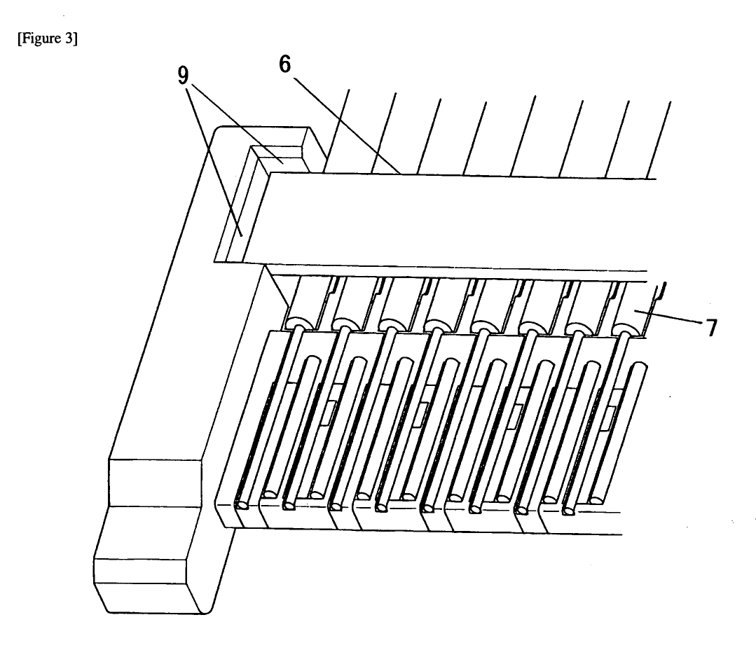

FIG. 2 is a cross sectional view of the state where a cooling member 1 is installed. A grounding bar 6 is placed on the shield 7 of the coaxial cable 2, and the grounding bar 6 and the shield 7 are put into contact with each other with a soldering device 5. Additionally, solder (not shown) is supplied between the shield 7 and the grounding bar 6. During soldering to the grounding bar 6, the coaxial cable 2 is aligned by the alignment means 8 which is for the aligning of each of the coaxial cables 2.

If soldering is performed in this state, the fluidified solder has a tendency to flow in by creeping along the shield 7. Here, since the melting point of solder is approximately 150 degrees Celsius, solder is a solid at any lower temperature. Due to the cooling member 1, only a small amount of heat travels to regions of the shield 7 other than the region that is being soldered to the grounding bar 6 of the coaxial cable 2, so that the coaxial cable 2 will be maintained at 150 degrees Celsius or below during the soldering step. Therefore, the solder will not flow into the coaxial cable side.

As shown in FIG. 2, the cooling member 1 has an opening portion through which the coaxial cable 2 passes, but the present invention is not restricted in this manner, and for example, it may be separated into a member on the upper side and a member on the lower side of the coaxial cable in FIG. 2, and when performing cooling, this can sandwich the coaxial cable 2 from above and below, thereby coming into contact with and cooling the coaxial cable.

In this way, by using the cooling member 1 of the present invention, the flowing of solder into the coaxial cable side can be prevented. Further, as shown in FIG. 3, the grounding bar 6 is in contact with the shield 7. Additionally, if said grounding bar can be fixed to the housing with solder, it will be extremely effective. Due to this method, the coaxial cable will exhibit flexibility, while securely fixing the end of the cable being handled. In the portion 9 where the housing and the grounding bar connect, metal is formed by, for example, MID. A grounding bar can be soldered onto this portion.

In the present invention, by putting a cooling member 1 next to and in contact with a region on which soldering is to be performed, the temperature of a coaxial cable 2 can be maintained at 150 degrees Celsius or below, thereby preventing the flow of solder into the coaxial cable side. Whereby, bending of the coaxial cable 2 can be done from the portion next to and in contact with the housing, without losing flexibility. This can be used, for example, in devices which demand miniaturization such as cellular telephones, and in particular, when a connector and a coaxial cable is passed through a small pass-through hole, a coaxial cable can be passed through the pass-through hole by bending it from the base of the connector.

1. A soldering method,
being a solder processing method for thin coaxial cables,
including a step for placing a coaxial cable shield on a grounding bar,
a step for supplying solder to the grounding bar or the shield,
a step for installing a cooling member next to and in contact with the grounding bar,
and a step for soldering the grounding bar and the coaxial cable together,
wherein the region of the coaxial cable next to and in contact with the cooling member is cooled, thereby preventing the flow of solder into regions other than the portions to be soldered.

2. A method according to claim 1, being a soldering method for thin coaxial cables, wherein soldering is performed while maintaining the temperature of the portion of the coaxial cable that is next to and in contact with the grounding bar at 150 degrees Celsius or below, by said process.

3. A cooling member, being a cooling member for soldering, said cooling member being able to have a coaxial cable pass through it, and having a pass-through hole for holding said coaxial cable, and a contact region that can come into contact with a region next to and in contact with the portion on which the soldering is to be done, and which, during soldering with a grounding bar, the heat that is conducted from the portion being soldered to the coaxial cable side is absorbed by the contact region, said region being able to be kept at below the melting point of the solder.

4. A cooling member according to claim 3, which can cool a cooling region to a cooling temperature of 150 degrees Celsius or below.

5. A grounding bar, having an end region for joining to a housing, which is fixed to a housing by joining together with solder said end region and a metal portion provided on the housing.
